(19) United States
(12) Patent Application Publication
(10) Pub. No.: US 2026/0269949 A1
(43) Pub. Date: Sep. 10, 2026

(54) COMMUNICATION METHOD, COMMUNICATION APPARATUS AND COMMUNICATION SYSTEM

(71) Applicant: NTT, Inc., Tokyo (JP)

(72) Inventors: Kazumitsu SAKAMOTO, Musashino-shi (JP); Takeshi KINOSHITA, Musashino-shi (JP); Takuya OHARA, Musashino-shi (JP); Etsushi YAMAZAKI, Musashino-shi (JP)

(73) Assignee: NTT,Inc., Tokyo (JP)

(21) Appl. No.: 18/721,590

(22) PCT Filed: Dec. 23, 2021
(86) PCT No.: PCT/JP2021/047873

§ 371 Date: Jun. 18, 2024

(51) Int. Cl. H04B 10/548; H04B 10/11; H04B 10/60

(52) U.S. Cl. CPC H04B 10/548; H04B 10/11; H04B 10/60

(57) ABSTRACT

A communication method executed by a communication device includes a step of detecting a distortion of a wavefront of an arriving light signal, a step of deriving each of components from a higher-order component to a lower-order component in the distortion of the wavefront, a step of controlling an inclination of a reflection surface of a first optical device that changes a propagation direction of the light signal that has arrived, according to the lower-order component, and a step of controlling a phase modulation operation using a second optical device that modulates a phase of the wavefront of the light signal of which the propagation direction has been changed, according to the higher-order component

### TECHNICAL FIELD

The present invention relates to a communication method, a communication device, and a communication system.

### BACKGROUND ART

Optical wireless communication between a transmitter and a receiver may be performed by using a light signal propagating in the atmosphere. In this case, a wavefront of the light signal is distorted due to the influence of the atmosphere. As a result, a spatial intensity (speckle) occurs in the light signal arriving at the receiver. This intensity pattern varies with time according to atmospheric fluctuations. This intensity pattern is a major hindrance in achieving stable optical wireless communication.

In order to suppress the influence of atmospheric fluctuations, adaptive optics for compensating for a distortion of a wavefront of a light signal according to closed-loop control has been studied (refer to Non Patent Document 1). In the adaptive optics, a receiver observes the influence of the fluctuation received from the atmosphere in a light signal transmitted from a transmitter (counter station). That is, the receiver observes the distortion (spatial phase distribution) of a wavefront of the light signal that has arrived. The receiver derives a compensation pattern for the distortion of the wavefront on the basis of the observation result. A wavefront control device provided in the receiver forms the compensation pattern for the distortion of the wavefront on the wavefront affected by the fluctuation. This improves the quality of optical wireless communication.

### CITATION LIST

### Non Patent Document

Non Patent Document 1: Yongxiong Ren, Guodong Xie, Hao Huang, Nisar Ahmed, Yan Yan, Long Li, Changjing Bao, Martin P. J. Lavery, Moshe Tur, Mark A. Neifeld, Robert W. Boyd, Jeffrey H. Shapiro, and Alan E. Willner, “Adaptive-optics-based simultaneous pre- and post-turbulence compensation of multiple orbital-angular-momentum beams in a bidirectional free-space optical link,” Optica 1, 376-382 (2014)

### SUMMARY OF INVENTION

### Technical Problem

In general, a lower-order component of atmospheric fluctuations (vertical or horizontal tilt component) is larger than a higher-order component of atmospheric fluctuations. In the adaptive optics disclosed in Non Patent Document 1, a deformable mirror forms a compensation pattern on a wavefront affected by a fluctuation. However, there is a problem that the cost of the communication device increases as the number of elements of the deformable mirror is increased in a communication device (receiver) in order to compensate for a high spatial frequency component included in the distortion of the wavefront.

The cost of a spatial light phase modulator (liquid crystal on silicon-spatial light modulator: LCOS-SLM) is low. The spatial light phase modulator can perform compensation with a high spatial resolution. However, in a case where the spatial light phase modulator forms the compensation pattern for the distortion of the wavefront in order to compensate for a large lower-order component, the influence of a stepwise change of the compensation pattern cannot be ignored. Thus, a beam of the light signal with the compensated wavefront collapses, and the diffraction efficiency of the light signal decreases. As described above, there is a problem that the accuracy of compensating for the distortion of the wavefront of the light signal having propagated in the atmosphere cannot be improved.

In view of the above circumstances, an object of the present invention is to provide a communication method, a communication device, and a communication system capable of improving accuracy of compensating for a distortion of a wavefront of a light signal having propagated in the atmosphere.

### Solution to Problem

According to an aspect of the present invention, there is provided a communication method executed by a communication device, the communication method including a step of detecting a distortion of a wavefront of a light signal; a step of deriving each of components from a higher-order component to a lower-order component in the distortion of the wavefront; a step of controlling an inclination of a reflection surface of a first optical device that changes a propagation direction of the light signal, according to the lower-order component; and a step of controlling a phase modulation operation using a second optical device that modulates a phase of the wavefront of the light signal of which the propagation direction has been changed, according to the higher-order component.

According to another aspect of the present invention, there is provided a communication device including a sensor that detects a distortion of a wavefront of a light signal; an analysis unit that derives each of components from a higher-order component to a lower-order component in the distortion of the wavefront; a first control unit that controls an inclination of a reflection surface of a first optical device that changes a propagation direction of the light signal, according to the lower-order component; and a second control unit that controls a phase modulation operation using a second optical device that modulates a phase of the wavefront of the light signal of which the propagation direction has been changed, according to the higher-order component.

According to still another aspect of the present invention, there is provided a communication system including a first communication device; and a second communication device, in which the first communication device includes a transmission unit that transmits a light signal, and the second communication device includes a sensor that detects a distortion of a wavefront of a light signal arriving from the first communication device, an analysis unit that derives each of components from a higher-order component to a lower-order component in the distortion of the wavefront, a first control unit that controls an inclination of a reflection surface of a first optical device that changes a propagation direction of the light signal that has arrived, according to the lower-order component, and a second control unit that controls a phase modulation operation using a second optical device that modulates a phase of the wavefront of the light signal of which the propagation direction has been changed, according to the higher-order component.

According to still another aspect of the present invention, there is provided a communication system including a first communication device; and a second communication device, in which the first communication device includes a transmission unit that transmits a light signal; a sensor that detects a distortion of a wavefront of a reference light signal transmitted from the second communication device, an analysis unit that derives each of components from a higher-order component to a lower-order component in the distortion of the wavefront, a first control unit that controls an inclination of a reflection surface of a first optical device that changes a propagation direction of the transmitted light signal, according to the lower-order component, and a second control unit that controls a phase modulation operation using a second optical device that modulates a phase of the wavefront of the light signal of which the propagation direction has been changed, according to the higher-order component, and the second communication device includes a reception unit that receives the light signal of which the phase has been modulated.

### Advantageous Effects of Invention

According to the present invention, it is possible to improve the accuracy of compensating for a distortion of a wavefront of a light signal having propagated in the atmosphere.

### BRIEF DESCRIPTION OF DRAWINGS

FIG. 1 is a diagram illustrating a configuration example of a communication system in a first embodiment.

FIG. 2 is a diagram illustrating an example of twelve Zernike modes in ascending order among Zernike polynomials according to the first embodiment.

FIG. 3 is a diagram illustrating an example of each component of a distortion of a wavefront in the first embodiment.

FIG. 4 is a diagram illustrating an example of each component selected in Zernike polynomials in the first embodiment.

FIG. 5 is a flowchart illustrating an operation example of the communication system in the first embodiment.

FIG. 6 is a view illustrating a configuration example of a communication system in a second embodiment.

FIG. 7 is a flowchart illustrating an operation example of the communication system in the second embodiment.

FIG. 8 is a diagram illustrating a hardware configuration example of a communication device in each embodiment.

### DESCRIPTION OF EMBODIMENTS

Embodiments of the present invention are described in detail with reference to the drawings.

### First Embodiment

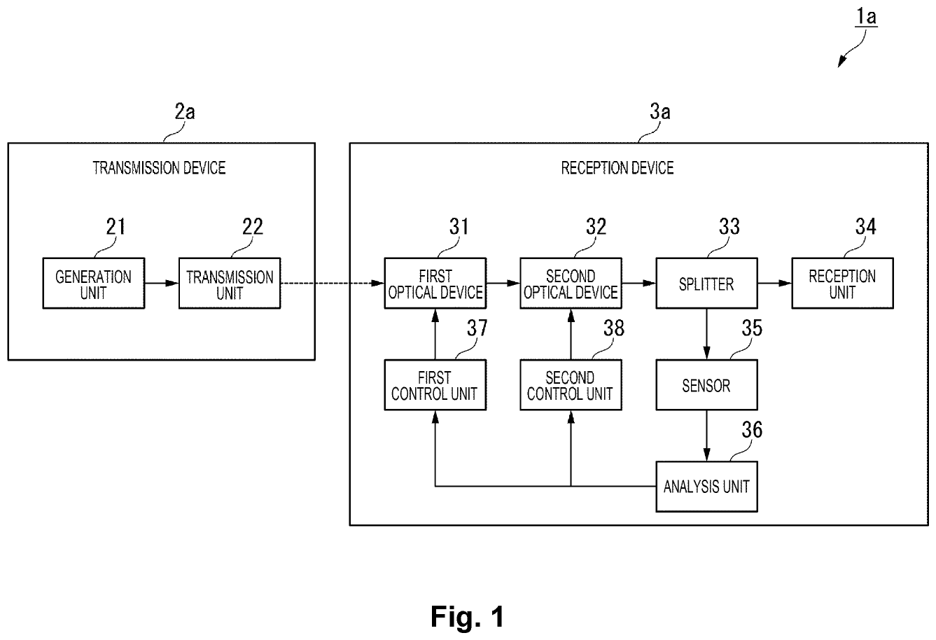

FIG. 1 is a diagram illustrating a configuration example of a communication system 1a according to a first embodiment. The communication system 1a is an optical communication system that executes wireless communication (optical wireless communication) by using a light signal.

The communication system 1a includes one or more transmission devices 2a (first communication devices) and one or more reception devices 3a (second communication devices). In the communication system 1a, a light signal propagates in the atmosphere between the transmission device 2a and the reception device 3a. In the first embodiment, the reception device 3a compensates for a distortion (aberration) generated in a wavefront of the light signal having propagated in the atmosphere by using adaptive optics. In the communication system 1a, for example, at least one of a tip-tilt mirror and a deformable mirror is used to compensate for a lower-order component (lower-order mode) of the distortion generated in the wavefront. For example, a spatial light phase modulator is used to compensate for a higher-order component (higher-order mode) of the distortion generated in the wavefront.

Next, the transmission device 2a will be described.

The transmission device 2a includes a generation unit 21 and a transmission unit 22. The generation unit 21 generates an electrical signal according to data. The transmission unit 22 converts the electrical signal into a light signal. The light signal transmitted from the transmission unit 22 propagates in the atmosphere and arrives at (enters) a first optical device 31.

Next, the reception device 3a will be described.

The reception device 3a includes the first optical device 31, a second optical device 32, a splitter 33, a reception unit 34, a sensor 35, an analysis unit 36, a first control unit 37, and a second control unit 38.

The first optical device 31 and the second optical device 32 have a multistage configuration. The first optical device 31 may be disposed at a preceding stage of the second optical device 32 or a subsequent stage of the second optical device 32. Hereinafter, the first optical device 31 is disposed at a preceding stage of the second optical device 32 as an example.

The first optical device 31 is a mirror. This mirror is, for example, at least one of a tip-tilt mirror and a deformable mirror. The first optical device 31 changes an inclination of a reflection surface of the first optical device 31 under the control of the first control unit 37. The first optical device 31 reflects the light signal transmitted by the transmission unit 22 in a direction according to the inclination of the first optical device 31. As described above, the first optical device 31 changes a propagation direction (deflection angle) of the light signal arriving at the first optical device 31 under the control of the first control unit 37.

The light signal of which the propagation direction has been changed by the first optical device 31 arrives at the second optical device 32. The second optical device 32 is a spatial light phase modulator. The second optical device 32 modulates the phase of the wavefront of the light signal of which the propagation direction has been changed. That is, the second optical device 32 modulates a phase of the wavefront of the light signal reflected by the first optical device 31. The light signal of which the phase of the wavefront has been modulated arrives at the splitter 33.

The splitter 33 splits the light signal of which the phase of the wavefront has been modulated by the second optical device 32 into the reception unit 34 and the sensor 35. The reception unit 34 converts the light signal arriving from the splitter 33 into an electrical signal. The reception unit 34 executes predetermined signal processing (for example, demodulation processing) on the converted electrical signal. The reception unit 34 acquires data transmitted from the transmission device 2a by using the light signal, from the electrical signal through the predetermined signal processing.

The sensor 35 is a wavefront sensor. The sensor 35 detects a distortion (aberration) of the wavefront of the light signal by observing a spatial phase distribution in the wavefront of the light signal split by the splitter 33. As a result, the sensor 35 detects the distortion of the wavefront of the light signal arriving at the splitter 33. The sensor 35 may detect the distortion of the wavefront of the light signal arriving at the first optical device 31 or the second optical device 32. The sensor 35 outputs a signal representing the distortion of the wavefront of the light signal to the analysis unit 36.

The analysis unit 36 acquires the signal representing the distortion of the wavefront of the light signal from the sensor 35. The analysis unit 36 derives each of components from a higher-order component to a lower-order component in the detected distortion of the wavefront. For example, the analysis unit 36 analyzes a breakdown of a plurality of components (modes) constituting the distortion of a wavefront by developing the distortion of the wavefront into Zernike polynomials. The analysis unit 36 outputs a signal representing each component derived through the analysis to the first control unit 37 and the second control unit 38.

The first control unit 37 selects a component having a predetermined first component amount or more from among predetermined lower-order components. That is, the first control unit 37 selects one or more main components from among the lower-order components. The first control unit 37 derives a phase conjugate pattern of the component selected from among the lower-order components as a compensation pattern for the lower-order components. The first control unit 37 controls an inclination of the reflection surface of the first optical device 31 according to the selected component. That is, the first control unit 37 controls the inclination of the reflection surface of the first optical device 31 by using the compensation pattern for the lower-order components. As a result, the first control unit 37 controls the propagation direction of the light signal received by the first optical device 31 according to the component selected from among the lower-order components.

The second control unit 38 may select all the higher-order components of the Zernike polynomials, but selects components having a predetermined second component amount or more (higher-order components of Zernike coefficients equal to or more than a threshold value) from among predetermined higher-order components. That is, the second control unit 38 selects a main component from among the higher-order components. The second control unit 38 derives a phase conjugate pattern of the component selected from among the higher-order components as a compensation pattern for the higher-order components. The second control unit 38 controls a phase modulation operation using the second optical device 32 according to the compensation pattern. As a result, the second control unit 38 controls the phase of the wavefront of the light signal arriving at the second optical device 32 according to the derived compensation pattern (phase conjugate pattern). Since the second control unit 38 selects a component having the predetermined second component amount or more from among the predetermined higher-order components, it is possible to reduce a calculation amount for compensation compared with a calculation amount in a case where all the higher-order components of the Zernike polynomials are selected. The calculation amount for compensation is, for example, a calculation amount for deriving a compensation pattern for a higher-order component and reconstructing a wavefront. Since the second control unit 38 can reduce a calculation amount for compensation, it is possible to improve a compensation processing speed for a distortion of a wavefront. Since the second control unit 38 can improve the compensation processing speed, it is possible to accurately compensate for a distortion of a wavefront following a time variation during atmospheric fluctuations.

Next, analysis of a distortion of a wavefront will be described.

The analysis unit 36 analyzes a breakdown of a plurality of components (modes) constituting a distortion of a wavefront by developing the distortion of the wavefront into Zernike polynomials. That is, the analysis unit 36 derives one or more Zernike modes (phase patterns) constituting the distortion of the wavefront (phase). The distortion “W r, θ)” of the wavefront is expressed as Formula (1).

$$[ Math . 1 ]$$

$$W ( r , θ ) = {\sum }_{i}^{∞} {a}_{i} {Z}_{i} \qquad ( 1 )$$

Here, “r” represents a distance from the origin in a polar coordinate system. “θ” represents a deflection angle in the polar coordinate system. “aᵢ” represents a Zernike coefficient. “i” represents a number of a Zernike mode. “Zᵢ” represents a Zernike mode. The Zernike mode “Zᵢ” is expressed by Formula (2).

$$[ Math . 2 ] .$$

$${Z}_{í} = {Z}_{n}^{m} ( r , θ ) = ( {\sum }_{s = 0}^{( n - m ) / 2} \frac{{( - 1 )}^{s} ( n - s ) ! {r}^{n - 2 s}}{s ! ( \frac{n + m}{2} - s ) ! ( \frac{n - m}{2} - s ) !} ) \qquad ( 2 )$$

$$\{ \begin{matrix}sin m θ : i odd \\ cos m θ : i even\end{matrix}$$

Here, “n” and “m” respectively represent an order. The order “n” is a non-negative integer. The order “m” is an integer satisfying “n>|m|”. “n” and “m” are determined according to the number “i” of the Zernike mode. The column vector “W” of the phase “W(r, θ)” of the wavefront is expressed by Formula (3).

$$[ Math . 3 ]$$

$$W = ZA \qquad ( 3 )$$

Here, “Z” on the right side of Formula (3) represents a column vector of the Zernike mode “Zᵢ”. The column vector of the Zernike mode “Zᵢ” is expressed by Formula (4).

$$[ Math . 4 ]$$

$$Z = [ {z}_{1} \vert {z}_{2} \vert ⋯ \vert {z}_{i} \vert ⋯ ] \qquad ( 4 )$$

The column vector “A” of the Zernike coefficient is expressed by Formula (5).

$$[ Math . 5 ]$$

$$A = [ \begin{matrix}{a}_{1} \\ {a}_{2} \\ ⋮ \\ {a}_{i} \\ ⋮\end{matrix} ] = {( {Z}^{T} Z )}^{- 1} {Z}^{T} W \qquad ( 5 )$$

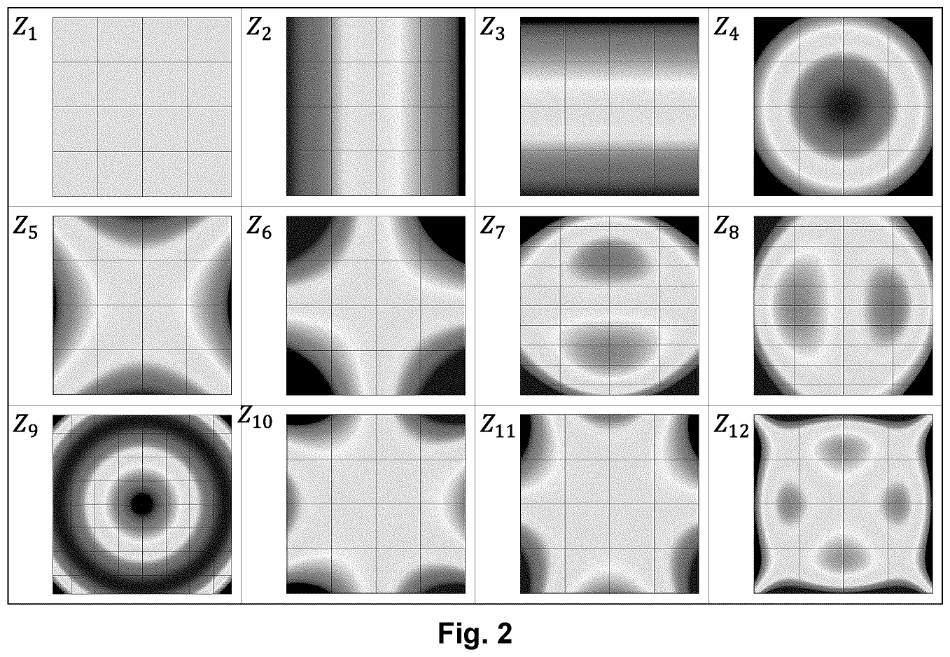

FIG. 2 is a diagram illustrating an example of twelve Zernike modes in ascending order among the Zernike polynomials according to the embodiment. The Zernike modes (respective components) are orthogonal to each other.

Hereinafter, a threshold for determining whether or not a component is a higher-order component (whether or not the component is not a lower-order component) is “4” as an example. Hereinafter, the predetermined first component amount is “3” as an example. Hereinafter, the predetermined second component amount is, for example, “0.5”.

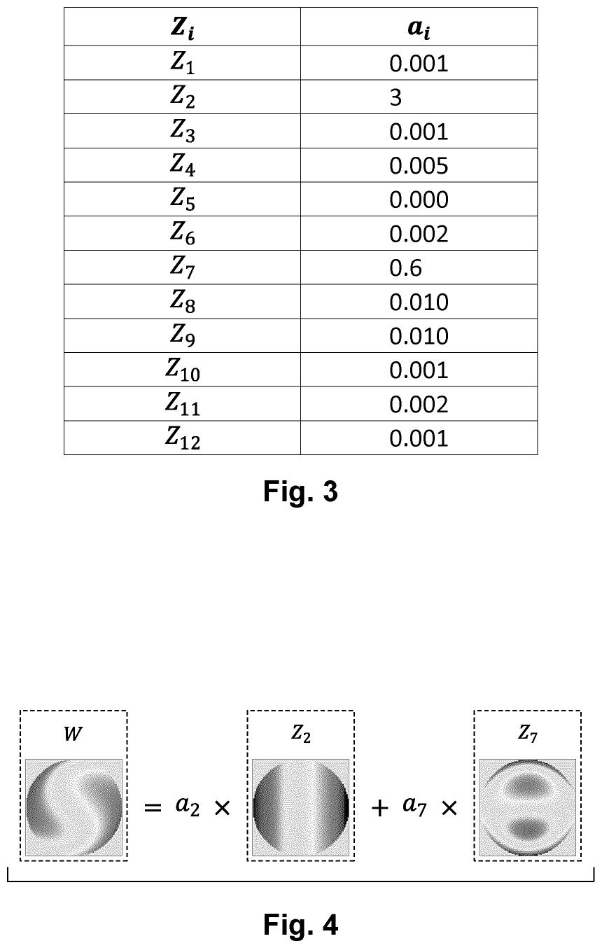

FIG. 3 is a diagram illustrating an example of each component of a distortion of a wavefront in the embodiment. Each component (each mode) from the Zernike modes “Z₁” to “Z₃” is a lower-order component (lower-order mode) less than the threshold “4” of the Zernike mode number. In FIG. 3, a component amount (Zernike coefficient “a₁”) “0.001” of the Zernike mode “Z₁” is less than the first component amount “3”. The component amount (Zernike coefficient “a₂”) “3” of the Zernike mode “Z₂” is equal to or more than the first component amount “3”. The component amount (Zernike coefficient “a₃”) “0.001” of the Zernike mode “Z₃” is less than the first component amount “3”.

Therefore, the first control unit 37 selects one or more Zernike modes indicating the first component amount “3” or more. The first optical device 31 is used for compensation of lower-order components. The first control unit 37 uses the selected Zernike mode “Z₂” to control an inclination of the first optical device 31 in order to compensate for the lower-order components of the distortion of the wavefront.

Each component (each mode) from the Zernike mode “Z₄” to “Z₁₂” is a higher-order component (higher-order mode) equal to or more than the threshold “4” of the Zernike mode number. In FIG. 3, the component amount “0.6” of the Zernike mode “Z₇” is equal to or more than the second component amount “0.5”.

Therefore, the second control unit 38 selects one or more Zernike modes indicating the second component amount “0.5” or more. The second optical device 32 is used for compensation of higher-order components. The second control unit 38 uses the selected Zernike mode “Z₇” to control an operation of the second optical device 32 (reconstruction of higher-order components of the distortion of the wavefront) in order to compensate for the higher-order components. For example, the second control unit 38 derives a phase pattern “(a₇×Z₇)=(0.5×Z₇)” constituting the distortion of the wavefront by using the selected Zernike mode “Z₇”. The second control unit 38 derives a phase conjugate pattern “−(0.5×Z₇)” of the phase pattern as a compensation pattern. The second control unit 38 controls an operation of the second optical device 32 such that the second optical device 32 forms the compensation pattern for the distortion of the wavefront on the wavefront.

FIG. 4 is a diagram illustrating an example of each component selected in Zernike polynomials in the embodiment; The column vector “W” of the phase “W(r, θ)” of the wavefront is expressed as a sum of the multiplication result of the Zernike coefficient “a₂” and the Zernike mode “Z₂” and the multiplication result of the Zernike coefficient “a₇” and the Zernike mode “Z₇”. That is, the phase pattern of the wavefront is expressed as “W=a₂×Z₂+a₇×Z₇”. Therefore, the compensation pattern (phase conjugate pattern) for the lower-order components is expressed as “−a₂×Z₂”. The compensation pattern (phase conjugate pattern) for the higher-order components is expressed as “−a₇×Z₇”.

The first control unit 37 derives the phase conjugate pattern “−a₂×Z₂” as a compensation pattern for the lower-order components. The first control unit 37 uses phase conjugate pattern “−a₂×Z₂” to control the inclination of the first optical device 31 in order to compensate for the lower-order components of the distortion of the wavefront.

The second control unit 38 derives the phase conjugate pattern “−a₇×Z₇” as a compensation pattern for the higher-order components. The second control unit 38 controls an operation of the second optical device 32 such that the second optical device 32 forms the compensation pattern “−a₇×Z₇” for the higher-order components on the wavefront.

Next, an operation example of the communication system 1a will be described.

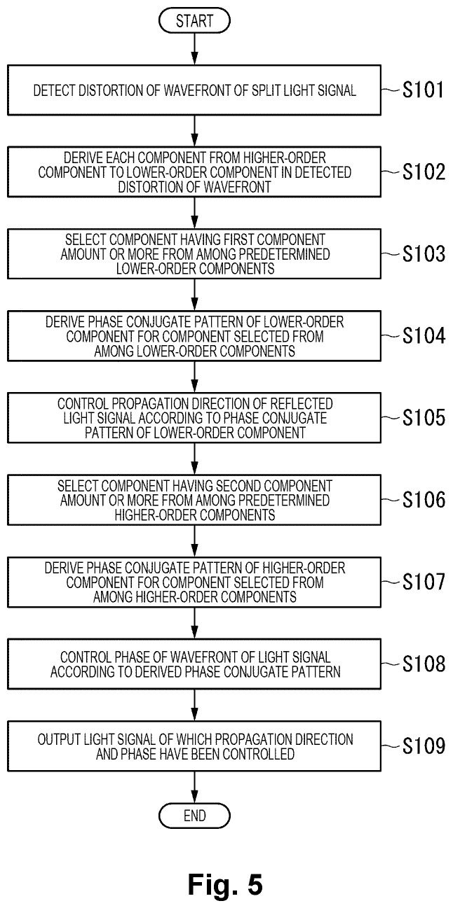

FIG. 5 is a flowchart illustrating an operation example of the communication system 1a according to the embodiment. The sensor 35 detects a distortion (aberration) of the wavefront of the light signal split by the splitter 33 (step S101). The analysis unit 36 derives each component (each orthogonal mode) from a higher-order component to a lower-order component in the detected distortion of the wavefront. That is, the analysis unit 36 develops the detection result of the distortion of the wavefront into Zernike polynomials (step S102).

The first control unit 37 selects a component having a first component amount or more from among predetermined lower-order components. For example, the first control unit 37 selects the Zernike mode “Z₂” having the first component amount “3” or more from the Zernike modes “Z₁”, “Z₂”, and “Z₃” of the third mode or less (step S103).

The first control unit 37 derives a phase conjugate pattern of the lower-order component for the component selected from among the lower-order components (step S104). The first control unit 37 controls a propagation direction of the light signal reflected by the first optical device 31 by changing an inclination of the reflection surface of the first optical device 31 according to the phase conjugate pattern of the lower-order component (step S105).

The second control unit 38 selects a component having a second component amount or more from among predetermined higher-order components (step S106). The second control unit 38 derives a phase conjugate pattern of the component selected from among the higher-order components (step S107). The second control unit 38 controls a phase of the wavefront of the light signal according to the derived phase conjugate pattern by using the second optical device 32 (step S108). The second optical device 32 outputs the light signal of which the propagation direction and the phase are controlled to the splitter 33 (step S109).

As described above, the transmission unit 22 of the transmission device 2a (first communication device) transmits a light signal. The sensor 35 of the reception device 3a (second communication device) detects a distortion of a wavefront of the light signal arriving from the splitter 33. That is, the sensor 35 detects the distortion of the wavefront of the light signal arriving from the transmission device 2a. The analysis unit 36 derives each of components from a higher-order component to a lower-order component in the distortion of the wavefront. The first control unit 37 controls an inclination of the reflection surface of the first optical device 31 that changes a propagation direction of the arriving light signal, according to the lower-order component. The second control unit 38 controls a phase modulation operation using the second optical device 32 that modulates a phase of the wavefront of the light signal of which the propagation direction has been changed, according to the higher-order component.

As a result, it is possible to improve the accuracy of compensating for the distortion of the wavefront of the light signal having propagated in the atmosphere. It is possible to accurately compensate for a high spatial frequency component (higher-order mode component) and a low spatial frequency component (lower-order mode component) in the distortion of the wavefront of the light signal. The communication system 1a can execute stable optical wireless communication.

At least one of the analysis unit 36, the first control unit 37, and the second control unit 38 may select a Zernike mode in which a component amount (Zernike coefficient) in the Zernike polynomials is equal to or larger than a predetermined component amount. The first control unit 37 may control an inclination of the reflection surface of the first optical device 31 according to the Zernike mode selected with respect to a lower-order component. The second control unit 38 may control a phase modulation operation using the second optical device 32 according to a Zernike mode selected with respect to a higher-order component.

### Second Embodiment

The second embodiment is different from the first embodiment in that a transmission device compensates for a distortion generated in a wavefront of a light signal after transmission before transmission of the light signal. In the second embodiment, differences from the first embodiment will be mainly described.

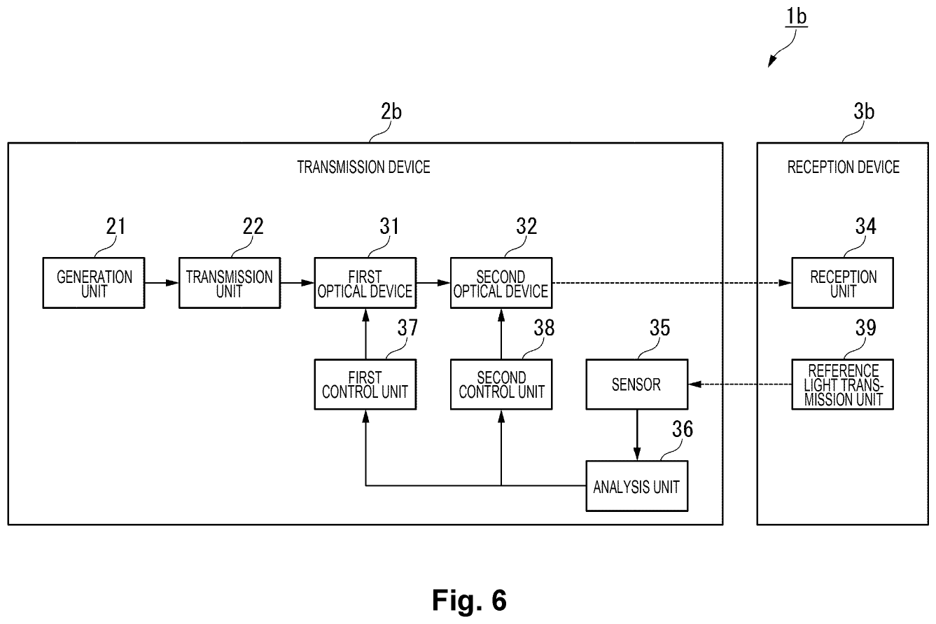

FIG. 6 is a diagram illustrating a configuration example of a communication system 1b in the second embodiment. The communication system 1b includes one or more transmission devices 2a (first communication devices) and one or more reception devices 3b (second communication devices). In the communication system 1b, a light signal transmitted from the transmission device 2b propagates toward the reception device 3b in the atmosphere between the transmission device 2b and the reception device 3b. In the communication system 1b, a reference light signal transmitted from the reception device 3b propagates toward the transmission device 2b in the atmosphere between the transmission device 2b and the reception device 3b. In the second embodiment, the transmission device 2b compensates for a distortion (aberration) generated in a wavefront of a light signal having propagated in the atmosphere by using adaptive optics.

The transmission device 2b includes a generation unit 21, a transmission unit 22, a first optical device 31, a second optical device 32, a sensor 35, an analysis unit 36, a first control unit 37, and a second control unit 38. The reception device 3b includes a reception unit 34 and a reference light transmission unit 39.

The second optical device 32 modulates a phase of a wavefront of a light signal reflected by the first optical device 31. The light signal of which the phase of the wavefront has been modulated arrives at the reception unit 34.

The reference light transmission unit 39 transmits a predetermined reference light signal to the sensor 35. The sensor 35 detects a distortion (aberration) of a wavefront of the reference light signal transmitted from the reference light transmission unit 39 by observing a spatial phase distribution in the wavefront of the reference light signal. The distortion of the wavefront of the reference light signal having propagated in the atmosphere is similar to the distortion of the wavefront of the light signal having propagated in the same atmosphere. The sensor 35 outputs a signal representing the distortion of the wavefront of the reference light signal to the analysis unit 36.

The analysis unit 36 acquires a signal indicating the distortion of the wavefront of the reference light signal from the sensor 35. The analysis unit 36 derives each of components from a higher-order component to a lower-order component in the detected distortion of the wavefront.

Next, an operation example of the communication system 1b will be described.

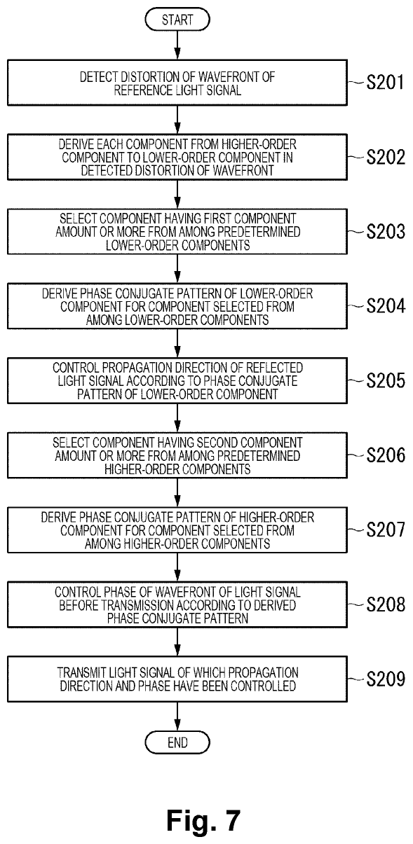

FIG. 7 is a flowchart illustrating an operation example of the communication system 1b in the second embodiment. The sensor 35 detects a distortion of a wavefront (aberration) of a reference light signal transmitted from the reference light transmission unit 39 (step S201). The analysis unit 36 derives each component (each orthogonal mode) from a higher-order component to a lower-order component in the detected distortion of the wavefront. That is, the analysis unit 36 develops the detection result of the distortion of the wavefront into Zernike polynomials (step S202).

The first control unit 37 selects a component having a first component amount or more from among predetermined lower-order components. For example, the first control unit 37 selects the Zernike mode “Z₂” having the first component amount “3” or more from the Zernike modes “Z₁”, “Z₂”, and “Z₃” of the third mode or less (step S203).

The first control unit 37 derives a phase conjugate pattern of the lower-order component for the component selected from among the lower-order components (step S204). The first control unit 37 controls a propagation direction of the light signal reflected by the first optical device 31 by changing an inclination of the reflection surface of the first optical device 31 according to the phase conjugate pattern of the lower-order component (step S205).

The second control unit 38 selects a component having a second component amount or more from among predetermined higher-order components (step S206). The second control unit 38 derives a phase conjugate pattern of the component selected from among the higher-order components (step S207). The second control unit 38 controls a phase of the wavefront of the light signal before transmission according to the derived phase conjugate pattern by using the second optical device 32 (step S208). The second optical device 32 outputs the light signal of which the propagation direction and the phase are controlled to the splitter 33 (step S209).

As described above, the transmission unit 22 of the transmission device 2b (first communication device) transmits a light signal to the first optical device 31. The sensor 35 detects a distortion of a wavefront of a reference light signal transmitted from the reception device 3b (second communication device). The analysis unit 36 derives each of components from a higher-order component to a lower-order component in the distortion of the wavefront. The first control unit 37 controls an inclination of the reflection surface of the first optical device 31 that changes a propagation direction of the transmitted light signal, according to the lower-order component. The second control unit 38 controls a phase modulation operation using the second optical device 32 that modulates a phase of the wavefront of the light signal of which the propagation direction has been changed, according to the higher-order component. The reception unit 34 of the reception device 3b receives the light signal of which the phase has been modulated.

As a result, it is possible to improve the accuracy of compensating for the distortion of the wavefront of the light signal having propagated in the atmosphere. It is possible to accurately compensate for a high spatial frequency component (higher-order mode component) and a low spatial frequency component (lower-order mode component) in the distortion of the wavefront of the light signal. The communication system 1b can execute stable optical wireless communication.

### Hardware Configuration Example

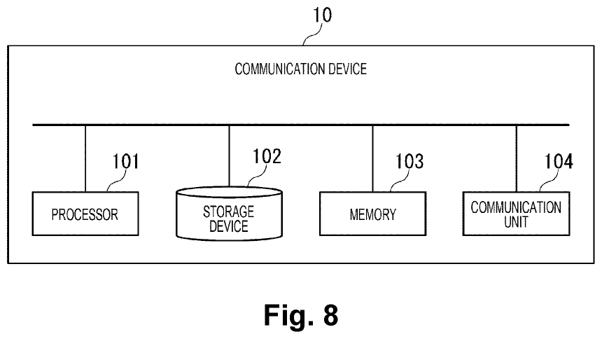

FIG. 8 is a diagram illustrating a hardware configuration example of a communication device 10 in each embodiment. The communication device 10 corresponds to at least one of the transmission device (first communication device) and the reception device (second communication device). Some or all of the functional units of the communication device 10 are realized as software by a processor 101 such as a central processing unit (CPU) executing a program stored in a storage device 102 including a nonvolatile recording medium (non-transitory recording medium) and a memory 103. The program may be recorded in a computer-readable non-transitory recording medium. The computer-readable non-transitory recording medium is, for example, a portable medium such as a flexible disk, a magneto-optical disk, a read only memory (ROM), or a compact disc read only memory (CD-ROM), or a non-transitory recording medium such as a storage device such as a hard disk built in a computer system. The communication unit 104 performs a predetermined communication process. The communication unit 104 may acquire data and a program.

Some or all of the functional units of the communication device 10 may be realized by using, for example, hardware including an electronic circuit (or circuitry) by using a large scale integrated circuit (LSI), an application specific integrated circuit (ASIC), a programmable logic device (PLD), a field programmable gate array (FPGA), or the like.

As described above, the embodiments of the present invention have been described in detail with reference to the drawings. On the other hand, the specific configuration is not limited to the embodiments, and includes design and the like without departing from the concept of the present invention.

### INDUSTRIAL APPLICABILITY

The present invention is applicable to an optical communication system that performs wireless communication by using a light signal.

### REFERENCE SIGNS LIST

1a, 1b Communication system
2, 2a, 2b Transmission device
3, 3a, 3b Reception device
21 Generation unit
22 Transmission unit
31 First optical device
32 Second optical device
33 Splitter
34 Reception unit
35 Sensor
36 Analysis unit
37 First control unit
38 Second control unit
39 Reference light transmission unit

1. A communication method executed by a communication device, the communication method comprising:
detecting a distortion of a wavefront of a light signal;
deriving each of components from a higher-order component to a lower-order component in the distortion of the wavefront;
controlling an inclination of a reflection surface of a first optical device that changes a propagation direction of the light signal, according to the lower-order component; and
controlling a phase modulation operation using a second optical device that modulates a phase of the wavefront of the light signal of which the propagation direction has been changed, according to the higher-order component.

2. The communication method according to claim 1, wherein
the first optical device is at least one of a tip-tilt mirror and a deformable mirror, and
the second optical device is a spatial light phase modulator.

3. The communication method according to claim 1, wherein
controlling according to the lower-order component includes selecting, with respect to the lower-order component, a Zernike mode in which a component amount in Zernike polynomials is equal to or larger than a first component amount, and controlling the inclination of the reflection surface according to the Zernike mode selected with respect to the lower-order component, and
controlling according to the higher-order component includes selecting, with respect to the higher-order component, a Zernike mode in which a component amount in the Zernike polynomials is equal to or larger than a second component amount, and controlling the phase modulation operation according to the Zernike mode selected with respect to the higher-order component.

4. The communication method according to claim 1, wherein
the light signal is a signal arriving at the communication device or a signal transmitted from the communication device.

5. A communication device comprising:
a sensor that detects a distortion of a wavefront of a light signal;
an analyzer that derives each of components from a higher-order component to a lower-order component in the distortion of the wavefront;
a first controller that controls an inclination of a reflection surface of a first optical device that changes a propagation direction of the light signal, according to the lower-order component; and
a second controller that controls a phase modulation operation using a second optical device that modulates a phase of the wavefront of the light signal of which the propagation direction has been changed, according to the higher-order component.

6. A communication system comprising:
a first communication device; and
a second communication device, wherein
the first communication device includes
a transmitter that transmits a light signal, and
the second communication device includes
a sensor that detects a distortion of a wavefront of a light signal arriving from the first communication device,
an analyzer that derives each of components from a higher-order component to a lower-order component in the distortion of the wavefront,
a first controller that controls an inclination of a reflection surface of a first optical device that changes a propagation direction of the light signal that has arrived, according to the lower-order component, and
a second controller that controls a phase modulation operation using a second optical device that modulates a phase of the wavefront of the light signal of which the propagation direction has been changed, according to the higher-order component.

7. A communication system comprising:
a first communication device; and
a second communication device, wherein
the first communication device includes
a transmitter that transmits a light signal;
a sensor that detects a distortion of a wavefront of a reference light signal transmitted from the second communication device,
an analyzer that derives each of components from a higher-order component to a lower-order component in the distortion of the wavefront,
a first controller that controls an inclination of a reflection surface of a first optical device that changes a propagation direction of the transmitted light signal, according to the lower-order component, and
a second controller that controls a phase modulation operation using a second optical device that modulates a phase of the wavefront of the light signal of which the propagation direction has been changed, according to the higher-order component, and
the second communication device includes
a receiver that receives the light signal of which the phase has been modulated.
